(19) United States
(12) Patent Application Publication
(10) Pub. No.: US 2007/0208794 A1
(43) Pub. Date: Sep. 6, 2007

(54) Conflict-free memory for fast walsh and inverse fast walsh transforms

(76) Inventor: Prashant Jain, Northglenn, CO (US)

Correspondence Address: TENSORCOMM, INC., 1490 W. 121ST AVE., SUITE 202, WESTMINISTER, CO, 80234, US

(21) Appl. No.: 11/301,771

(22) Filed: Dec. 13, 2005

(51) Int. Cl. G06F 17/14

(52) U.S. Cl. 708/403

(57) ABSTRACT

An address generation component performs in-place address assignments and memory-selection circuitry provides a specific pattern of data storage to avoid memory conflicts that may occur during a fast Walsh transform (FWT) operation.

### BACKGROUND

1. Field of the invention

The present invention relates generally to interference cancellation in received wireless communication signals and, more particularly, to forming and using a composite interference signal for interference cancellation.

2. Discussion of the Related Art

Fast Walsh Transform (FWT) computations can be performed in place, wherein the inputs and the outputs of the FWT butterfly operations share the same memory, thus eliminating the intermediate storage requirements. A 64-point transform requires six steps as part of its FWT operations, wherein each step consists of 32 additions and 32 subtractions. If a dual-port sample memory block is used to store all 64 samples, it takes two cycles to read the operands for a single addition and subtraction. Thus, 32 cycles are required to finish a single step of an FWT using just one adder and one subtractor to perform 32 additions and 32 subtractions.

If a lower latency is desired, extra adders and subtractors can be used to perform multiple operations in parallel. For example, a system employing four adders and four subtractors allows four additions and four subtractions to be performed in parallel, thus requiring only eight cycles to finish an FWT step. However, parallel operations require higher memory bandwidth. This requires a single 64-sample dual-port memory to be broken down into multiple memory banks, which increases the bandwidth by as many times as the number of banks. In the previously recited case wherein four adders and four subtractors are employed, eight operands are processed in every clock cycle. Therefore, eight memory banks storing eight samples each are required. The eight memory banks are read every cycle to obtain the eight required operands for the four additions and four subtractions. The eight memory banks and the samples stored in them are shown in FIG. 1.

The problem with this storage architecture is that as the FWT operations progress, there are conflicts within the memory banks (i.e., multiple operands are required from the same memory bank in a given cycle). For example, in step 3 of a 6-step 64-point FWT, operands numbered 1 and 9 are required. Since these operands are stored in the same memory bank, two cycles are needed to access them. Meanwhile, not all memory banks are accessed during a specific cycle, which is an inefficient use of the available memory bandwidth. For example, banks 5 to 8 are not read during the accessing of samples (1,9), (2,10), (3,11) and (4,12) in step 3.

Therefore, there is a need in CDMA transceivers that employ FWTs to perform memory management for avoiding memory conflicts and ensuring a more efficient use of available memory bandwidth.

### SUMMARY OF THE INVENTION

In view of the foregoing background, embodiments of the present invention may be employed in systems configured to perform FWTs. FWT circuits and memory storage patterns described herein may be employed in subscriber-side devices (e.g., cellular handsets, wireless modems, and consumer premises, equipment) and/or server-side devices (e.g., cellular base stations, wireless access points, wireless routers, wireless relays, and repeaters). Chipsets for subscriber-side and/or server-side devices may be configured to perform at least some of the memory management functionality of the embodiments described herein.

Embodiments of the invention include memory-selection circuitry to provide a specific pattern of data storage to avoid memory conflicts that may occur during an FWT operation when accessing a memory bank. The regular pattern of an FWT allows for the design of a storage pattern to avoid memory conflicts. An address generation component may be configured to provide for in-place address assignments. Memory size requirements can be minimized by using in-place address assignments, which require the outputs of each butterfly calculation to be stored in the same memory locations used by the inputs. Output addresses may include various permutations of the input addresses to a given butterfly, and the permutations may vary for each butterfly. Exemplary embodiments shown herein employ the same address for outputs and inputs on the same wing of each butterfly. Such assignments may employ the same address-generation hardware for both the butterfly inputs and the butterfly outputs. However, alternative embodiments may be employed, such as embodiments that require different hardware for the output and input addresses.

Various functional elements, separately or in combination, depicted in the figures may take the form of a microprocessor, digital signal processor, application specific integrated circuit, field programmable gate array, or other logic circuitry programmed or otherwise configured to operate as described herein. Accordingly, embodiments may take the form of programmable features executed by a common processor or discrete hardware unit.

These and other embodiments of the invention are described with respect to the figures and the following description of the preferred embodiments.

### BRIEF DESCRIPTION OF THE DRAWINGS

Embodiments according to the present invention are understood with reference to the memory storage diagrams of FIGS. 1, 2B, 3A, 3B, and 4, and the flow diagram of FIG. 5.

FIG. 1 shows eight memory banks configured to store 64 samples.

FIG. 2A illustrates a butterfly operation for an exemplary 8-point FWT.

FIG. 2B shows a storage pattern implemented in memory banks M1-M4 for inputs to an exemplary 8-point FWT butterfly.

FIG. 3A shows a storage pattern in accordance with an embodiment of the invention for a 64-point FWT that avoids conflicts between memory banks M1-M8.

FIG. 3B shows another embodiment of the invention comprising only two banks, wherein each row in a bank stores four consecutive samples.

FIG. 4 shows an exemplary conflict-free storage pattern for 64 data samples in four banks.

FIG. 5 shows an exemplary method for arranging samples for conflict-free memory assignments.

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

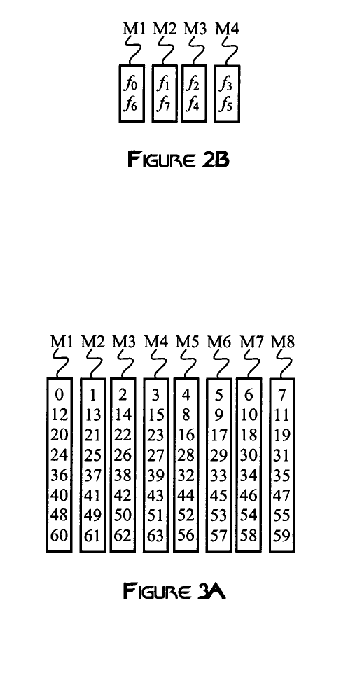

FIG. 2A illustrates a butterfly operation for an exemplary 8-point FWT. In this case, input values f₀-f₇ are combined (such as indicated by standard notation wherein solid lines indicate addition and dashed lines represent subtraction) to produce values g₀-g₇. This process continues until output values i₀-i₇ are produced.

$$\vert \begin{matrix}{f}_{0} \\ {f}_{1} \\ {f}_{2} \\ {f}_{3} \\ {f}_{4} \\ {f}_{5} \\ {f}_{6} \\ {f}_{7}\end{matrix} \vert \to \vert \begin{matrix}{g}_{0} = {f}_{0} + {f}_{4} \\ {g}_{1} = {f}_{1} + {f}_{5} \\ {g}_{2} = {f}_{2} + {f}_{6} \\ {g}_{3} = {f}_{3} + {f}_{7} \\ {g}_{4} = {f}_{0} - {f}_{4} \\ {g}_{5} = {f}_{1} - {f}_{5} \\ {g}_{6} = {f}_{2} - {f}_{6} \\ {g}_{7} = {f}_{3} - {f}_{7}\end{matrix} \vert \to \vert \begin{matrix}{h}_{0} = {g}_{0} + {g}_{2} \\ {h}_{1} = {g}_{1} + {g}_{3} \\ {h}_{2} = {g}_{0} - {g}_{2} \\ {h}_{3} = {g}_{1} - {g}_{3} \\ {h}_{4} = {g}_{4} + {g}_{6} \\ {h}_{5} = {g}_{5} + {g}_{7} \\ {h}_{6} = {g}_{4} - {g}_{6} \\ {h}_{7} = {g}_{5} - {g}_{7}\end{matrix} \vert \to \vert \begin{matrix}{i}_{0} = {h}_{0} + {h}_{1} \\ {i}_{1} = {h}_{0} - {h}_{1} \\ {i}_{2} = {h}_{2} + {h}_{3} \\ {i}_{3} = {h}_{2} - {h}_{3} \\ {i}_{4} = {h}_{4} + {h}_{5} \\ {i}_{5} = {h}_{4} - {h}_{5} \\ {i}_{6} = {h}_{6} + {h}_{7} \\ {i}_{7} = {h}_{6} - {h}_{7}\end{matrix} \vert$$

It should be appreciated that such processes may be reversed, and embodiments of the invention may provide corresponding procedures for data storage to avoid memory conflicts.

To ensure maximum memory bandwidth efficiency, the number of memory banks and the organization of data in the memory banks are selected such that all memory banks are accessed in each clock cycle. Since each memory bank can be accessed only once per clock cycle, a preferred storage pattern would require that no samples required to interact with each other during any of the FWT steps be stored in the same memory bank. Thus, for conflict-free address assignments, the intermediate data must be in separate memory banks for the butterfly calculations in the preceding and succeeding columns.

FIG. 2B shows a storage pattern implemented in memory banks M1-M4 for inputs to exemplary 8-point FWT butterfly. The storage pattern represents indices of the operands employed in each stage of the FWT operation. In this case, f₀ and f₆ are stored in M1, f₁ and f₇ are stored in M2, f₂ and f₄ are stored in M3, and f₃ and f₅ are stored in M4. In a first clock cycle, f₀ and f₄ are accessed from M1 and M3, respectively, to produce g₀ and g₄. The butterfly illustrates that the operands f₀ and f₄ should be in different memory banks in order to be accessed in one clock cycle for the first FWT stage. Similarly, f₁ and f₅ are accessed from M2 and M4, respectively, to produce g₁ and g₅. The new operands g₀, g₁, g₄, and g₅ are input to the memory banks M1, M2, M3, and M4, respectively.

The second and third stages of the FWT follow the butterfly procedure shown in FIG. 2A. The butterfly shows that all operands indexed by zero should not be stored in the same bank as operands indexed by four, two, or one. Similarly, operands indexed by six should not be paired with operands indexed by two, four, or seven. Such exclusion relationships for each of the operands help produce the storage pattern shown in FIG. 2B, in which the operands indexed by one and seven are included in the same memory bank M1.

FIG. 3A shows a storage pattern for a 64-point FWT that avoids conflicts between memory banks M1-M8. During each stage of the FWT, the memory banks M1-M8 are accessed at the maximum memory bandwidth. It is important to note that during an access, the first four banks (M1-M4) share an address (row) and the next four banks (M5-M8) share another address that could be the same as the address for the first four banks. Since multiple banks share the same address, they can be combined to form a single bank.

FIG. 3B shows another embodiment of the invention comprising only two banks, wherein each row in a bank stores four consecutive samples. The storage patterns shown in FIGS. 3A and 3B can be obtained by assuming that the total number of adders and subtractors is 2^{M}. The row length is 2^{M}.

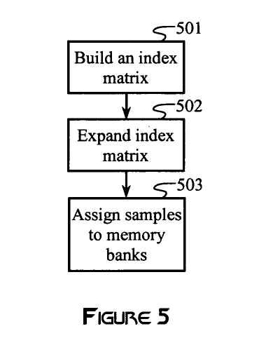

FIG. 5 shows an exemplary method for arranging samples for conflict-free memory assignments. Building an index matrix 501 may comprise a first step of arranging, in order, a first set of 2^{M} samples from left to right as shown in FIGS. 3A and 3B. In FIG. 3A, each sample is assigned to its own memory bank Mₘ. In FIG. 3B, the first 2^{M-1} samples are arranged in bank M301 and the next 2^{M-1} samples are arranged in bank M302. Assigning samples to memory banks 503 may be performed concurrently with arranging the sample order (such as indicated with respect to building the index matrix 501 and expanding the index matrix 502) or may be performed once the sample order arrangement is complete.

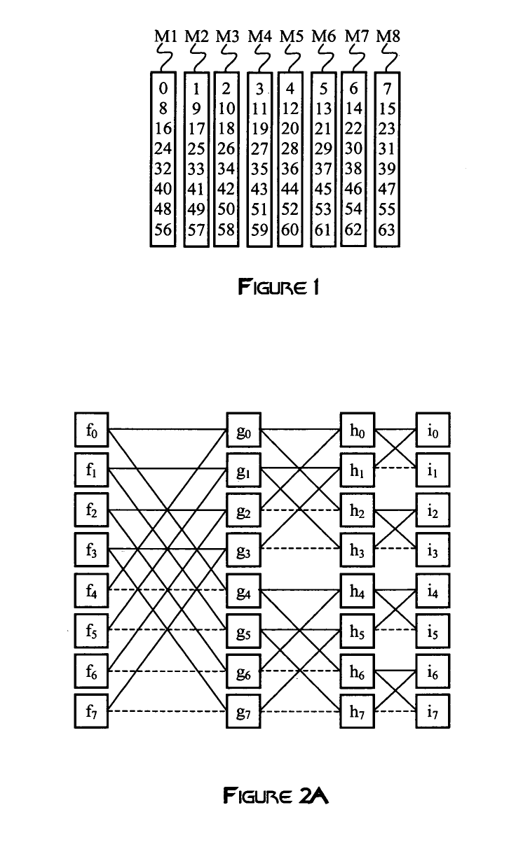

FIG. 1 shows an index matrix in its natural order. However, it is desirable to shift this matrix into a conflict-free index matrix, such as shown in FIG. 3A, 3B, or 4. The conflict-free index matrix has first and second halves of a row swapped if and only if the binary representation for the row n=b_{M-1} . . . b₀ has an odd number of bits. For example, the first and second halves of row 1=0 0 1 are swapped, whereas the first and second halves of row 5=1 0 1 are not.

The following table represents which rows are swapped (denoted by a swap code of “1”) and which rows are not swapped (denoted by a swap code of “0”).

| Row | Binary Representation | Swap Code |
|---|---|---|
| 0 | 0 0 0 | 0 |
| 1 | 0 0 1 | 1 |
| 2 | 0 1 0 | 1 |
| 3 | 0 1 1 | 0 |
| 4 | 1 0 0 | 1 |
| 5 | 1 0 1 | 0 |
| 6 | 1 1 0 | 0 |
| 7 | 1 1 1 | 1 |

The swap codes may be assembled into a vector s₂_{^{N}}=[0 1 1 0 1 0 0 1] (where 2^{N} represents the number of rows) and generated recursively as follows:
s₀=[0],
s₂=[s₀ s̅₀]=[0 1],
s₄=[s₂ s̅₂]=[0 1 1 0],
s₈=[s₄ s̅₄]=[0 1 1 0 1 0 0 1],
where overbar denotes a complement. Thus, a general recursion formula may be represented as
s₀[0],
s₂_{ⁿ}=└s₂_{ⁿ⁻¹} s̅₂_{ⁿ⁻¹}┘, n=1, 2, . . . , N.

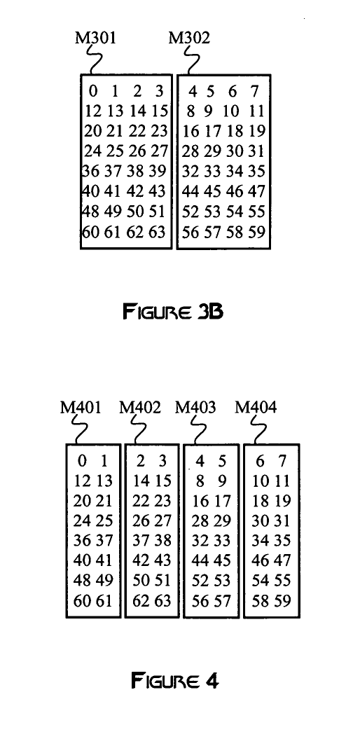

FIG. 4 shows an exemplary conflict-free storage pattern for 64 data samples in four banks. Storage patterns may be generated for alternative configurations having different numbers of samples and/or data banks. Embodiments of the invention may be used in the design of low-latency and hardware-efficient FWT and IFWT operations used for channel estimation in CDMA, WCDMA, and other communication protocols. Multiple transforms may be cascaded using the same memory management scheme (e.g. an FWT followed by an Inverse FWT or in mixed transforms where an FWT is followed by an FFT or vice versa).

Processing hardware for fast Walsh transforms, in accordance with embodiments of the invention, can be made faster by simultaneously fetching operands for multiple butterfly computations, performing operations in parallel, and then writing them back simultaneously. In an exemplary embodiment, a machine architecture may divide transform vector memory into two independently-addressable banks and employ an order permutation for the in-place vector in this architecture that permits the transform to proceed in-place, without the need to move data between the banks.

The functions of the various elements shown in the drawings, including functional blocks, may be provided through the use of dedicated hardware, as well as hardware capable of executing software in association with appropriate software. When provided by a processor, the functions may be performed by a single dedicated processor, by a shared processor, or by a plurality of individual processors, some of which may be shared. Moreover, explicit use of the term “processor” should not be construed to refer exclusively to hardware capable of executing software, and may implicitly include, without limitation, digital signal processor DSP hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as applying without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include currently known equivalents as well as equivalents developed in the future, i.e., any elements developed that perform the same function, regardless of structure.

1. A system configured for providing a conflict-free memory in a Fast Walsh Transform (FWT), comprising
an address generation component configured to provide for in-place address assignments, and
a memory-selection circuitry configured to provide a pattern of data storage that avoids memory conflicts during an FWT operation.

2. The system recited in claim 1, wherein the address generation component is configured to employ the same address for outputs and inputs on the same wing of each butterfly.

3. The system recited in claim 1, wherein the address generation component includes common address-generation hardware for both butterfly inputs and butterfly outputs.

4. The system recited in claim 1, wherein the address generation component includes one set of address-generation hardware for butterfly inputs and a different set of address-generation hardware for butterfly outputs.

5. The system recited in claim 1, further configured to reside in at least one of a microprocessor, a digital signal processor, an application specific integrated circuit, and a field programmable gate array.

6. The system recited in claim 1, configured to function with an inverse-FWT operation.

7. The system recited in claim 1, wherein the memory-selection circuitry is configured to employ an index matrix for providing the pattern of data storage.

8. The system recited in claim 7, wherein the memory-selection circuitry is configured to recursively generate swap codes.

9. A method for providing conflict-free memory in a Fast Walsh Transform (FWT) operation, comprising
providing for performing in-place address assignments, and
providing for producing a pattern of data storage that avoids memory conflicts during the FWT operation.

10. The method recited in claim 9, wherein providing for performing in-place address assignments is configured to employ the same address for outputs and inputs on the same wing of each butterfly.

11. The method recited in claim 9, wherein providing for performing in-place address assignments includes accessing common address-generation hardware for both butterfly inputs and butterfly outputs.

12. The method recited in claim 9, wherein providing for performing in-place address assignments includes accessing a first address-generation hardware for butterfly inputs and a second set of address-generation hardware for butterfly outputs.

13. At least one of a microprocessor, a digital signal processor, an application specific integrated circuit, and a field programmable gate array configured to perform the method recited in claim 9.

14. The method recited in claim 9, configured for functioning with an inverse-FWT operation.

15. The method recited in claim 9, wherein providing for producing a pattern of data storage includes employing an index matrix.

16. The method recited in claim 15, wherein providing for producing a pattern of data storage is configured to recursively generate swap codes.

17. A system for providing conflict-free memory in a Fast Walsh Transform (FWT) operation, comprising
a means for performing in-place address assignments, and
a means for storing data in a pattern that avoids memory conflicts during the FWT operation.

18. The system recited in claim 17, wherein the means for performing in-place address assignments is configured to employ the same address for outputs and inputs on the same wing of each butterfly.

19. The system recited in claim 17, wherein the means for performing in-place address assignments includes accessing common address-generation hardware for both butterfly inputs and butterfly outputs.

20. The system recited in claim 17, wherein the means for performing in-place address assignments includes accessing a first address-generation hardware for butterfly inputs and a second set of address-generation hardware for butterfly outputs.

21. The system recited in claim 17, configured for performing an inverse-FWT operation.

22. The system recited in claim 17, wherein the means for storing data is configured to employ an index matrix.

23. The system recited in claim 22, wherein the means for storing data is configured to recursively generate swap codes.

24. A system configured for providing a conflict-free memory in a Fast Walsh Transform (FWT), comprising
an address generation component configured to provide for in-place address assignments, and
a memory-selection circuitry configured for organizing a memory into a pair of 2^{M-1}-wide, 2^{N}-deep memory banks, and providing for conflict-free access of initial, intermediate, and final values used in a 2^{N+M}-point FWT operation.

25. The system recited in claim 24, wherein the address generation component is configured to employ the same address for outputs and inputs on the same wing of each butterfly.

26. The system recited in claim 24, wherein the address generation component includes common address-generation hardware for both butterfly inputs and butterfly outputs.

27. The system recited in claim 24, wherein the address generation component includes one set of address-generation hardware for butterfly inputs and a different set of address-generation hardware for butterfly outputs.

28. The system recited in claim 24, further configured to reside in at least one of a microprocessor, a digital signal processor, an application specific integrated circuit, and a field programmable gate array.

29. The conflict-free memory system recited in claim 24, configured to function with an inverse-FWT operation.

30. The system recited in claim 24, wherein the memory-selection circuitry is configured to employ an index matrix for providing the pattern of data storage.

31. The system recited in claim 30, wherein the memory-selection circuitry is configured to recursively generate swap codes.

32. A method for providing conflict-free memory in a Fast Walsh Transform (FWT) operation, comprising
providing for performing in-place address assignments, and
providing for organizing a memory into a pair of 2^{M-1}-wide, 2^{N}-deep memory banks and providing for conflict-free access of initial, intermediate, and final values used in a 2^{N+M}-point FWT operation.

33. The method recited in claim 32, wherein providing for performing in-place address assignments is configured to employ the same address for outputs and inputs on the same wing of each butterfly.

34. The method recited in claim 32, wherein providing for performing in-place address assignments includes accessing common address-generation hardware for both butterfly inputs and butterfly outputs.

35. The method recited in claim 32, wherein providing for performing in-place address assignments includes accessing a first address-generation hardware for butterfly inputs and a second set of address-generation hardware for butterfly outputs.

36. At least one of a microprocessor, a digital signal processor, an application specific integrated circuit, and a field programmable gate array configured to perform the method recited in claim 32.

37. The method recited in claim 32, configured for functioning with an inverse-FWT operation.

38. The method recited in claim 32, wherein providing for organizing includes employing an index matrix.

39. The method recited in claim 38, wherein providing for organizing is configured to recursively generate swap codes.

40. A system for providing conflict-free memory in a Fast Walsh Transform (FWT) operation, comprising
a means for performing in-place address assignments, and
a means for organizing a memory into a pair of 2^{M-1}-wide, 2^{N}-deep memory banks and providing for conflict-free access of initial, intermediate, and final values used in a 2^{N+M}-point FWT operation.

41. The system recited in claim 40, wherein the means for performing in-place address assignments is configured to employ the same address for outputs and inputs on the same wing of each butterfly.

42. The system recited in claim 40, wherein the means for performing in-place address assignments includes accessing common address-generation hardware for both butterfly inputs and butterfly outputs.

43. The system recited in claim 40, wherein the means for performing in-place address assignments includes accessing a first address-generation hardware for butterfly inputs and a second set of address-generation hardware for butterfly outputs.

44. The system recited in claim 40, configured for performing an inverse-FWT operation.

45. The system recited in claim 40, wherein the means for organizing is configured to employ an index matrix.

46. The system recited in claim 45, wherein the means for organizing is configured to recursively generate swap codes.
